(19) United States
(12) Patent Application Publication
(10) Pub. No.: US 2014/0122058 A1
(43) Pub. Date: May 1, 2014

(54) Automatic Transcription Improvement Through Utilization of Subtractive Transcription Analysis

(71) Applicant: INTERNATIONAL BUSINESS MACHINES CORPORATION, Armonk, NY (US)

(72) Inventors: Seth E. Bravin, Frederick, MD (US); Brian J. Cragun, Rochester, MN (US); Ali Sobhi, Austin, TX (US)

(73) Assignee: International Business Machines Corporation, Armonk, NY (US)

(21) Appl. No.: 13/663,536

(22) Filed: Oct. 30, 2012

(51) Int. Cl. G06F 17/27

(52) U.S. Cl. 704/9

(57) ABSTRACT

A mechanism is provided for subtractive transcript improvement. The mechanism identifies a set of corrections made to a previous transcript, where the set of corrections comprise, for each correction in the set of corrections, an erred phrase and a correction made to the erred phrase. For each erred phrase in a set of erred phrases in a current transcript, the mechanism determines whether the erred phrase in the current transcript matches an erred phrase in the set of corrections made to the previous transcript. Responsive to the erred phrase in the current transcript matching an erred phrase in the set of corrections made to the previous transcript, the mechanism corrects the erred phrase in the current transcript with the correction made to the erred phrase in the previous transcript.

### BACKGROUND

The present application relates generally to an improved data processing apparatus and method and more specifically to mechanisms for improving automatic transcription through utilization of subtractive transcription analysis.

Speech recognition (SR) is the translation of spoken words into text. Speech recognition, also known as automatic speech recognition (ASR), utilize “training”, where an individual speaker reads sections of text into the SR system, the SR system analyzes the person's specific voice and fine tunes the recognition of that person's speech, resulting in more accurate transcription. The utilization of voice recognition may simplify the task of translating speech in systems that have been trained on specific person's voices or may be used to authenticate or verify the identity of a speaker as part of a security process.

However, voice recognition alone only provides some improvement to the accuracy of the transcription. That is, the accuracy of automatic translation systems are also improved by developers running test cases and tweaking the automatic translation systems rules to produce better results. However, constant tweaking requires numerous man-hours which results in increased cost.

### SUMMARY

In one illustrative embodiment, a method, in a data processing system, is provided for subtractive transcript improvement. The illustrative embodiment identifies a set of corrections made to a previous transcript. In the illustrative embodiment, the set of corrections comprise, for each correction in the set of corrections, an erred phrase and a correction made to the erred phrase. The illustrative embodiment determines whether the erred phrase in the current transcript matches an erred phrase in the set of corrections made to the previous transcript for each erred phrase in a set of erred phrases in a current transcript. The illustrative embodiment corrects the erred phrase in the current transcript with the correction made to the erred phrase in the previous transcript in response to the erred phrase in the current transcript matching an erred phrase in the set of corrections made to the previous transcript.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts an example of a subtractive transcription improvement system in accordance with an illustrative embodiment; and

FIGS. 4A and 4B depict a flowchart of an exemplary operation performed by a subtractive transcription improvement system in accordance with an illustrative embodiment.

### DETAILED DESCRIPTION

The illustrative embodiments provide mechanisms that intelligently determine transcription errors in a current transcription and corrections for those errors through subtractive transcription analysis based on a previous transcription. The mechanisms identify a set of transcription errors in a previous transcription and a set of corrections made to correct the set of transcription errors in the previous transcription. The mechanisms then utilize the set of transcription errors and the set of corrections made to correct the set of transcription errors in the previous transcription to analyze a current transcription. That is, if a previous transcription has been corrected for a particular person, on a particular topic, at a particular location, or the like, the mechanisms analyze and store the set of transcription errors in the previous transcription and the set of corrections made to correct the set of transcription errors in the previous transcription. The mechanisms then utilize the set of transcription errors and the set of corrections made to correct the set of transcription errors in the previous transcription to analyze and correct the current transcription for the particular person, on the particular topic, at the particular location, or the like.

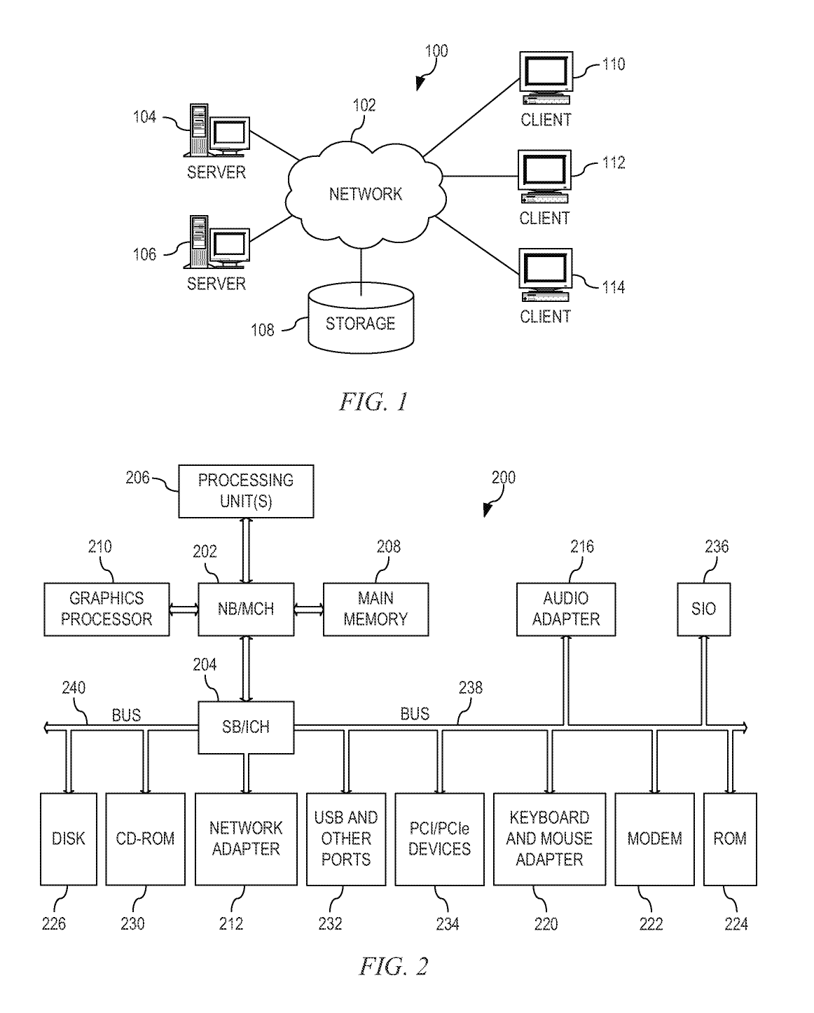

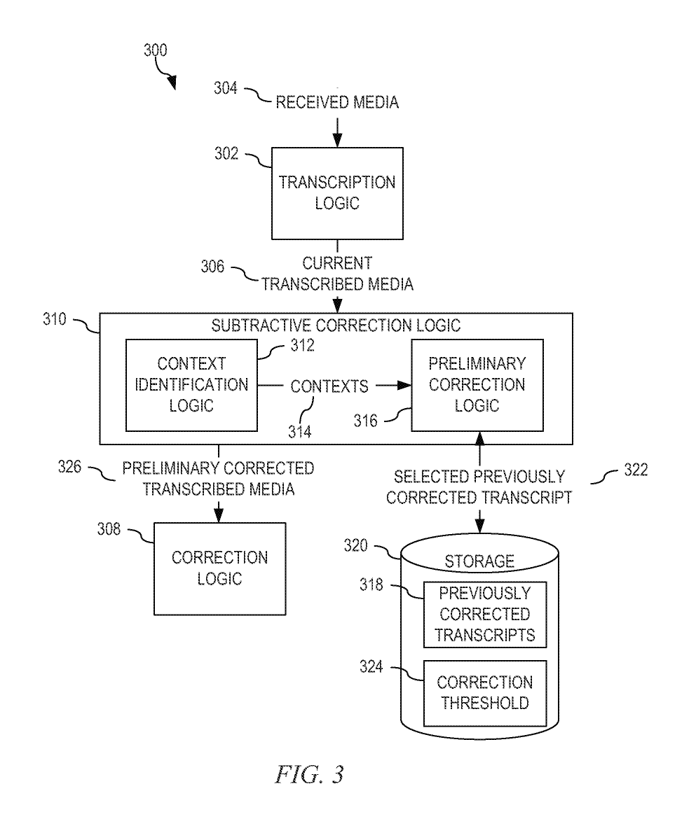

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

The illustrative embodiments provide mechanisms that intelligently determine transcription errors in a current transcription and corrections for those errors through subtractive transcription analysis based on a previous transcription. Again, if a previous transcription has been corrected for a particular person, on a particular topic, at a particular location, or the like, then the mechanisms utilize a set of transcription errors and a set of corrections made to correct the set of transcription errors in the previous transcription to analyze and correct a current transcription for the particular person, on the particular topic, at the particular location, or the like. Thus, for a current transcription that has yet to be corrected by a transcription correction system, the mechanisms of the illustrative embodiments may provide an initial correction to the transcription based on corrections to a previous transcription that is related to the current transcription. Though the current transcription may not be improved to perfection, statistically, the current transcription will have an improved accuracy and a more accurate starting place than a raw transcript.

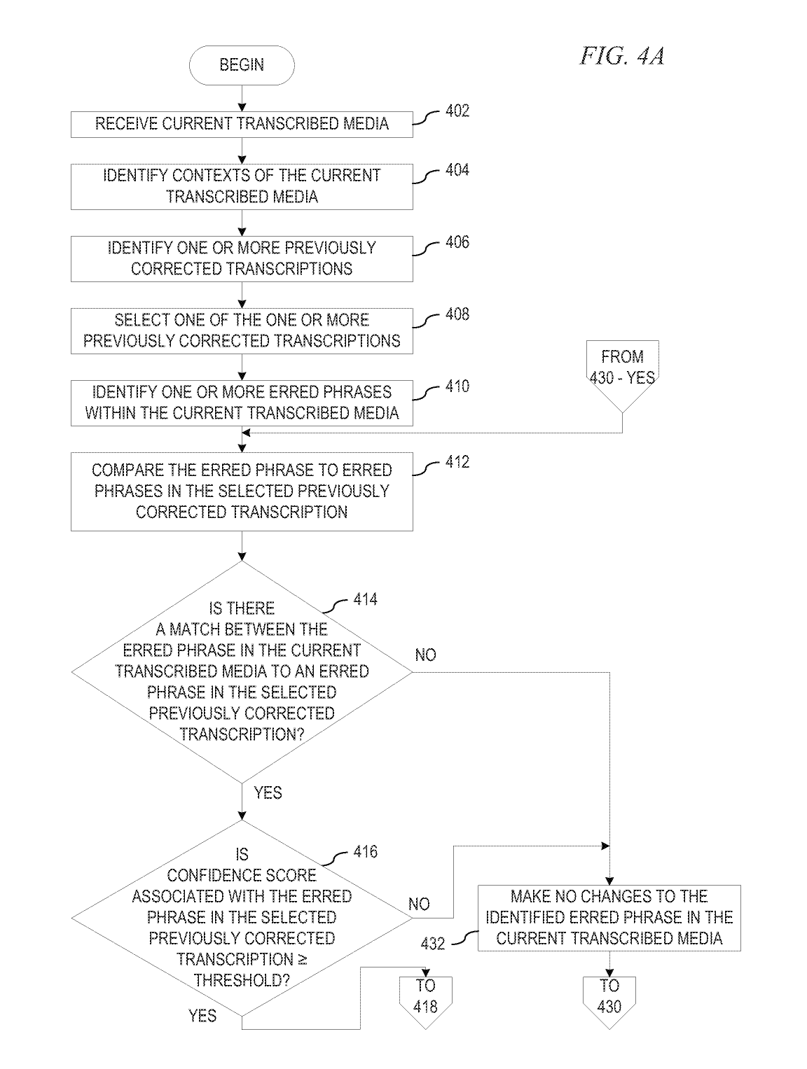

FIG. 3 depicts an example of a subtractive transcription improvement system in accordance with an illustrative embodiment. Subtractive transcription improvement system 300 comprises transcription logic 302 that transcribes received media 304 in order to provide current transcribed media 306. Prior to correction logic 308 performing standard correction on current transcribed media 306 as would be performed in current transcriptions systems, subtractive correction logic 310 receives current transcribed media 306. Subtractive correction logic 310 comprises context identification logic 312 that identifies contexts 314 of current transcribed media 306 utilizing contexts from current transcribed media 306, such as identification of a speaker, topics being discussed, language being used, or the like. While current transcribed media 306 may only cover one context, one of ordinary skill in the art will readily recognize that some media may cover a plurality of contexts, such as a political campaign transcription. Thus, context identification logic 312 identifies all contexts 314 of current transcribed media 306. Additionally, context identification logic 312 may identify contexts 314 of current transcribed media 306 based on metadata that is embedded in current transcribed media 306, which may have been captured and forwarded by transcription logic 302 when transcribing received media 304.

Subtractive correction logic 310 further comprises preliminary correction logic 316 that utilizes one or more of contexts 314 to identify one or more previously corrected transcriptions from a set of previously corrected transcriptions 318 on storage 320 that has a context that is the same as or similar to contexts 314 above a predetermined threshold. That is, each previously corrected transcription in the set of previously corrected transcriptions 318 has a confidence score associated with the previously corrected transcription, which may be a confidence score assigned by a user or automated transcription service. Alternatively, each previously corrected transcription in the set of previously corrected transcriptions 318 may have a confidence score that is an average confidence score based on confidence scores associated with each of the corrections made to erred content elements within the previously corrected transcription.

Upon identifying one or more previously corrected transcriptions from a set of previously corrected transcriptions 318 that has a same or similar context to contexts 314, preliminary correction logic 316 selects one of the one or more previously corrected transcriptions that has a confidence score higher than the other previously corrected transcriptions in the one or more previously corrected transcriptions. If two or more previously corrected transcriptions have the same highest confidence score, the preliminary correction logic 316 randomly selects one of the two or more previously corrected transcriptions. After selecting previously corrected transcription 322, preliminary correction logic 316 identifies one or more erred phrases within current transcribed media 306, each phrase comprising one or more consecutive words. Preliminary correction logic 316 then compares the one or more erred phrases in current transcribed media 306 to erred phrases in selected previously corrected transcription 322. That is, selected previously corrected transcription 322 comprises erred phrases, corrections made to the erred phrase, and a confidence score associated with the corrections made to the erred phrase.

If preliminary correction logic 316 identifies an erred phrase in current transcribed media 306 that matches an erred phrase in selected previously corrected transcription 322, preliminary correction logic 316 determines whether the confidence score associated with the erred phrase in selected previously corrected transcription 322 is greater than or equal to predetermined correction threshold 324. If the confidence score is greater than or equal to predetermined correction threshold 324, then preliminary correction logic 316 may automatically correct the identified erred phrase in current transcribed media 306 with the associated correction in selected previously corrected transcription 322. The illustrative embodiments recognize that rather than automatically making the correction of the identified erred phrase, preliminary correction logic 316 may prompt an administrator for an indication to proceed with the correction. In the prompt, preliminary correction logic 316 provides the user with the erred phrase from current transcribed media 306 and the suggested correction to the erred phrase from selected previously corrected transcription 322. If the administrator indicates that the correction may be made, then preliminary correction logic 316 corrects the identified erred phrase in current transcribed media 306 with the associated correction in selected previously corrected transcription 322.

If the administrator indicates that the correction should not be made or if the confidence level is less than predetermined correction threshold 324, then preliminary correction logic 316 makes no changes as supplemental corrections will be performed by correction logic 308. Once preliminary correction logic 316 analyzes all of the content within current transcribed media 306 and automatically corrects one or more other identified erred phrases, preliminary correction logic 316 produces preliminary corrected transcribed media 326 that includes current transcribed media 306 with identified erred phrases and corrections made to one or more of the identified erred phrases. Preliminary correction logic 316 then sends preliminary corrected transcribed media 326 to correction logic 308 for standard correction for those phrases not already corrected by preliminary correction logic 316.

As a further process of the illustrative embodiments, as preliminary correction logic 316 corrects the identified erred phrase in current transcribed media 306 with the associated correction in selected previously corrected transcription 322 either automatically or per indication from the administrator, preliminary correction logic 316 further updates the confidence score associated with the correction made based on the erred phrase in selected previously corrected transcription 322 by a predetermined value to indicate the correction is more prevalent. Further, preliminary correction logic 316 may associate a confidence score with correction made to the erred phrase in current transcribed media 306 based on the updates to the confidence score associated with the correction utilized from selected previously corrected transcription 322.

Thus, the illustrative embodiments provide advantages current automated transcription processes by utilizing corrections made in previously corrected transcriptions to correct identifiable errors made in a current transcription. While the corrections made by utilizing corrections made in previously corrected transcriptions may not result in a perfectly transcribed media, the corrections provide a statistically more accurate starting place than uncorrected transcribed media.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

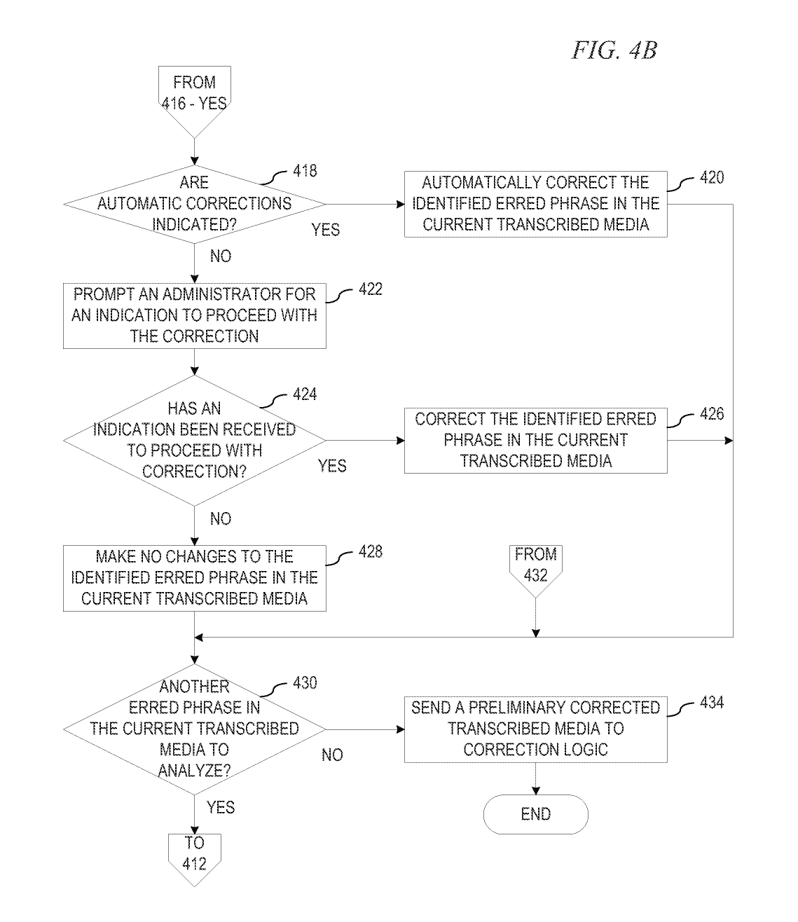

FIGS. 4A and 4B depict a flowchart of an exemplary operation performed by a subtractive transcription improvement system in accordance with an illustrative embodiment. As the operation begins, subtractive correction logic, such as subtractive correction logic 310 of FIG. 3, executed by a processor, such as processing unit 206 of FIG. 2, receives a current transcribed media (step 402). The subtractive correction logic identifies contexts of the current transcribed media utilizing contexts from the current transcribed media (step 404). The subtractive correction logic utilizes the identified contexts in order to identify one or more previously corrected transcriptions from a set of previously corrected transcriptions that have contexts that are the same as or similar to the identified contexts above a predetermined threshold (step 406).

Upon identifying one or more previously corrected transcriptions from the set of previously corrected transcriptions that has a same or similar contexts to the identified contexts, the subtractive correction logic selects one of the one or more previously corrected transcriptions that has a confidence score higher than the other previously corrected transcriptions in the one or more previously corrected transcriptions (step 408). If two or more previously corrected transcriptions have the same highest confidence score, the subtractive correction logic randomly selects one of the two or more previously corrected transcriptions. After selecting a previously corrected transcription, the subtractive correction logic identifies one or more erred phrases within the current transcribed media (step 410), each phrase comprising one or more consecutive words. For each erred phrase in the one or more erred phrases in the current transcribed media, the subtractive correction logic compares the erred phrase to erred phrases in the selected previously corrected transcription (step 412). The selected previously corrected transcription comprises erred phrases, corrections made to the erred phrase, and a confidence score associated with the corrections made to the erred phrase.

The subtractive correction logic then determines whether there is a match between the erred phrase in the current transcribed media to an erred phrase in the selected previously corrected transcription (step 414). If at step 414 the subtractive correction logic identifies an erred phrase in the current transcribed media that matches an erred phrase in the selected previously corrected transcription, the subtractive correction logic determines whether the confidence score associated with the erred phrase in the selected previously corrected transcription is greater than or equal to a predetermined correction threshold (step 416). If at step 416 the subtractive correction logic determines that the confidence score is greater than or equal to the predetermined automatic correction threshold, then the subtractive correction logic determines whether automatic corrections are indicated (step 418). If at step 418 the subtractive correction logic determines that automatic corrections are indicated, then the subtractive correction logic automatically corrects the identified erred phrase in the current transcribed media with the associated correction in the selected previously corrected transcription (step 420).

If at step 418 the subtractive correction logic determines that automatic corrections are not indicated, the subtractive correction logic prompts an administrator for an indication to proceed with the correction (step 422). The subtractive correction logic then determines whether an indication has been received to proceed with the correction (step 424). If at step 424 the subtractive correction logic receives an indication to proceed with the correction, then the subtractive correction logic corrects the identified erred phrase in the current transcribed media with the associated correction in the selected previously corrected transcription (step 426). If at step 424 the subtractive correction logic receives a denial to proceed with the correction, the subtractive correction logic makes no changes (step 428). Then from steps 420, 426, or 428, the subtractive correction logic determines whether there is another erred phrase in the current transcribed media to analyze (step 430).

If at step 414 the subtractive correction logic fails to identify an erred phrase in the current transcribed media that matches an erred phrase in the selected previously corrected transcription or if at step 416 the subtractive correction logic determines that the confidence score is less than the predetermined automatic correction threshold, the subtractive correction logic makes no changes (step 432), with the operation proceeding to step 430 thereafter. If at step 430 the subtractive correction logic determines that there is another erred phrase in the current transcribed media to analyze, then the operation returns to step 412. If at step 430 the subtractive correction logic determines that there is no other erred phrase in the current transcribed media to analyze, then the subtractive correction logic sends a preliminary corrected transcribed media to correction logic for standard correction for those phrases not already corrected by the subtractive correction logic (step 434), with the operation terminating thereafter.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms that intelligently determine transcription errors in a current transcription and corrections for those errors through subtractive transcription analysis based on a previous transcription. If a previous transcription has been corrected for a particular person, on a particular topic, at a particular location, or the like, then the mechanisms utilize a set of transcription errors and a set of corrections made to correct the set of transcription errors in the previous transcription to analyze and correct a current transcription for the particular person, on the particular topic, at the particular location, or the like. Thus, for a current transcription that has yet to be corrected by a transcription correction system, the mechanisms of the illustrative embodiments may provide an initial correction to the transcription based on corrections to a previous transcription that is related to the current transcription. Though the current transcription may not be improved to perfection, statistically, the current transcription will have an improved accuracy and a more accurate starting place than a raw transcript.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for subtractive transcript improvement, the method comprising:
identifying, by a processor, a set of corrections made to a previous transcript, wherein the set of corrections comprise, for each correction in the set of corrections, an erred phrase and a correction made to the erred phrase;
for each erred phrase in a set of erred phrases in a current transcript, determining, by the processor, whether the erred phrase in the current transcript matches an erred phrase in the set of corrections made to the previous transcript; and
responsive to the erred phrase in the current transcript matching an erred phrase in the set of corrections made to the previous transcript, correcting, by the processor, the erred phrase in the current transcript with the correction made to the erred phrase in the previous transcript.

2. The method of claim 1, wherein the erred phrase in the previous transcript and the erred phrase in the current transcript is either a word or a continuous set of words.

3. The method of claim 1, further comprising:
prior to correcting the erred phrase in the current transcript with the correction made to the erred phrase, determining, by the processor, whether a confidence score of the correction made to the erred phrase is greater than or equal to a predetermined correction threshold; and
responsive to the confidence score of the correction made to the erred phrase being greater than or equal to the predetermined correction threshold, correcting, by the processor, the erred phrase in the current transcript with the correction made to the erred phrase in the previous transcript.

4. The method of claim 3, further comprising:
responsive to correcting the erred phrase in the current transcript with the correction made to the erred phrase, updating, by the processor, the confidence score of the correction made to the erred phrase in the previous transcript.

5. The method of claim 1, further comprising:
prior to correcting the erred phrase in the current transcript with the correction made to the erred phrase, prompting, by the processor, an administrator for an indication to proceed with the correction; and
responsive to receiving a positive indication to proceed with the correction, correcting, by the processor, the erred phrase in the current transcript with the correction made to the erred phrase in the previous transcript.

6. The method of claim 1, wherein the correction of the erred phrase in the current transcript with the correction made to the erred phrase in the previous transcript is performed automatically without prompting an administrator.

7. The method of claim 1, wherein the previous transcript is identified based on contexts of the current transcript matching the previous transcript within a predetermined threshold.

8. A computer program product comprising a computer readable storage medium having a computer readable program stored therein, wherein the computer readable program, when executed on a computing device, causes the computing device to:
identify a set of corrections made to a previous transcript, wherein the set of corrections comprise, for each correction in the set of corrections, an erred phrase and a correction made to the erred phrase;
for each erred phrase in a set of erred phrases in a current transcript, determine whether the erred phrase in the current transcript matches an erred phrase in the set of corrections made to the previous transcript; and
responsive to the erred phrase in the current transcript matching an erred phrase in the set of corrections made to the previous transcript, correct the erred phrase in the current transcript with the correction made to the erred phrase in the previous transcript.

9. The computer program product of claim 8, wherein the erred phrase in the previous transcript and the erred phrase in the current transcript is either a word or a continuous set of words.

10. The computer program product of claim 8, wherein the computer readable program further causes the computing device to:
prior to correcting the erred phrase in the current transcript with the correction made to the erred phrase, determine whether a confidence score of the correction made to the erred phrase is greater than or equal to a predetermined correction threshold; and
responsive to the confidence score of the correction made to the erred phrase being greater than or equal to the predetermined correction threshold, correct the erred phrase in the current transcript with the correction made to the erred phrase in the previous transcript.

11. The computer program product of claim 10, wherein the computer readable program further causes the computing device to:
responsive to correcting the erred phrase in the current transcript with the correction made to the erred phrase, update the confidence score of the correction made to the erred phrase in the previous transcript.

12. The computer program product of claim 8, wherein the computer readable program further causes the computing device to:
prior to correcting the erred phrase in the current transcript with the correction made to the erred phrase, prompt an administrator for an indication to proceed with the correction; and
responsive to receiving a positive indication to proceed with the correction, correct the erred phrase in the current transcript with the correction made to the erred phrase in the previous transcript.

13. The computer program product of claim 8, wherein the correction of the erred phrase in the current transcript with the correction made to the erred phrase in the previous transcript is performed automatically without prompting an administrator.

14. The computer program product of claim 8, wherein the previous transcript is identified based on contexts of the current transcript matching the previous transcript within a predetermined threshold.

15. An apparatus, comprising:
a processor; and
a memory coupled to the processor, wherein the memory comprises instructions which, when executed by the processor, cause the processor to:
identify a set of corrections made to a previous transcript, wherein the set of corrections comprise, for each correction in the set of corrections, an erred phrase and a correction made to the erred phrase;
for each erred phrase in a set of erred phrases in a current transcript, determine whether the erred phrase in the current transcript matches an erred phrase in the set of corrections made to the previous transcript; and
responsive to the erred phrase in the current transcript matching an erred phrase in the set of corrections made to the previous transcript, correct the erred phrase in the current transcript with the correction made to the erred phrase in the previous transcript.

16. The apparatus of claim 15, wherein the erred phrase in the previous transcript and the erred phrase in the current transcript is either a word or a continuous set of words.

17. The apparatus of claim 15, wherein the instructions further cause the processor to:
prior to correcting the erred phrase in the current transcript with the correction made to the erred phrase, determine whether a confidence score of the correction made to the erred phrase is greater than or equal to a predetermined correction threshold; and
responsive to the confidence score of the correction made to the erred phrase being greater than or equal to the predetermined correction threshold, correct the erred phrase in the current transcript with the correction made to the erred phrase in the previous transcript.

18. The apparatus of claim 17, wherein the instructions further cause the processor to:
responsive to correcting the erred phrase in the current transcript with the correction made to the erred phrase, update the confidence score of the correction made to the erred phrase in the previous transcript.

19. The apparatus of claim 15, wherein the instructions further cause the processor to:
prior to correcting the erred phrase in the current transcript with the correction made to the erred phrase, prompt an administrator for an indication to proceed with the correction; and
responsive to receiving a positive indication to proceed with the correction, correct the erred phrase in the current transcript with the correction made to the erred phrase in the previous transcript.

20. The apparatus of claim 15, wherein the correction of the erred phrase in the current transcript with the correction made to the erred phrase in the previous transcript is performed automatically without prompting an administrator.

21. The apparatus of claim 15, wherein the previous transcript is identified based on contexts of the current transcript matching the previous transcript within a predetermined threshold.
